(19) United States
(12) Patent Application Publication
(10) Pub. No.: US 2026/0318670 A1
(43) Pub. Date: Oct. 15, 2026

(54) INTERFERENCE REFLECTION MICROSCOPE AND METHOD FOR ANALYSING A SAMPLE

(71) Applicant: Augment Biotechnology, Inc., New York, NY (US)

(72) Inventors: Erik SCHÄFFER, New York, NY (US); Anita JANNASCH, New York, NY (US); Sandro MÜNCH, New York, NY (US); Tom STUMPP, New York, NY (US); Viktoria WEDLER, New York, NY (US)

(21) Appl. No.: 19/126,398

(22) PCT Filed: Oct. 26, 2023
(86) PCT No.: PCT/EP2023/079981

§ 371 Date: May 18, 2026

(30) Foreign Application Priority Data
Nov. 1, 2022 (DE) 10 2022 128 898.6

(51) Int. Cl. G01B 9/02; G01B 11/24; G01N 15/1434; G02B 21/06; G02B 21/36

(52) U.S. Cl. CPC G01B 9/02041; G01B 9/02034; G01B 11/2441; G01N 15/1434; G02B 21/06; G02B 21/36; G01N 2015/1454

(57) ABSTRACT

The disclosure relates to an interference reflection microscope which is operated with a light source which is spatially coherent and temporally incoherent. As a result, the formation of speckle patterns can be avoided and filters for filtering out such speckle patterns are no longer required. The disclosure also relates to an associated method.

### TECHNICAL FIELD

The disclosure relates to an interference reflection microscope and a method for analyzing a sample using such an interference reflection microscope.

### BACKGROUND

Microscopes are generally used for different types of examination or observation of samples. One possible design of a microscope is an interference reflection microscope, which typically illuminates a sample with an excitation light and uses reflected light for evaluation. Due to interference effects, information content can arise in the light, which, for example, allows photometric mass spectrometry of molecules.

An exemplary implementation is disclosed in Young et al., Science 360, 423-427 (2018) and the accompanying supplementary material. In this implementation, a central obstruction filter is used to suppress speckle patterns.

### SUMMARY

It is an object per an embodiment to provide an interference reflection microscope which is alternative or better than known designs. It is a further object per an embodiment to provide a corresponding method for analyzing a sample.

This is achieved according to an embodiment by an interference reflection microscope and a method according to the respective main claims. Advantageous embodiments can be found, for example, in the respective subclaims. The content of the claims is made part of the description by express reference.

The disclosure relates to an interference reflection microscope. The interference reflection microscope has a light source, illumination optics, a sample arrangement, detection optics and a detector. The illumination optics directs light from the light source as excitation light onto the sample arrangement. The detection optics direct light reflected from the sample arrangement onto the detector. It is advantageous that the light source is spatially coherent, per an embodiment. It is also advantageous that the light source is temporally incoherent, per an embodiment.

In such an interference reflection microscope, the design of the light source has the advantage, per an embodiment, that the formation of speckle patterns in the reflected light can be prevented due to the temporal incoherence of the light source. Such patterns typically arise as interference phenomena due to unavoidable roughness, impurities or chemical heterogeneity of a surface of the sample arrangement and/or the illumination or detection optics. In known designs, they typically interfere with the evaluation to a considerable extent, which is why they are filtered out using strong filters in the beam path. Although such filters allow for better evaluation without significant interference from speckle patterns, they also result in a significant loss of the light reflected back from the sample. This in turn means that with known designs, considerably more radiance must be used in order to still have sufficient light intensity for evaluation even after a filter. Such high light outputs can especially cause organic molecules to bleach or be destroyed when examining them. In the present design of an interference reflection microscope, however, it is possible to significantly reduce the power density on a sample, which in turn allows a longer exposure time without damaging molecules.

An interference reflection microscope is basically a microscope in which a sample is illuminated and in which reflected and/or scattered light is collected and evaluated, in particular in a direction which is at least approximately opposite to the illuminating light. This light basically contains information that arises due to interference effects. Such interference effects can occur in particular due to interface transitions, for example between glass and liquid or between liquid and sample or due to distances between sample and glass. Instead of glass, for example, a transparent plastic can also be used. As a sample, for example, a molecule, in particular an organic molecule and in particular a molecule with a mass of for example several kDa (kilodaltons), can be used. Several such molecules can also be used.

A characteristic of an interference reflection microscope is that the interference occurs at the sample or at least in the immediate vicinity of the sample, for example at a distance of at most 100 nm, at most 1 mm, at most 10 mm, at most 100 mm or at most 1 mm from the sample, for example at an interface between glass and liquid or between liquid and sample. This distinguishes an interference reflection microscope from designs of microscopes that have a separate path into which light from a main light beam is coupled, which then interferes with light reflected from the sample. Such separate paths are typically not present in interference reflection microscopes.

The light source is used to generate the excitation light. The illumination optics direct the excitation light onto the sample arrangement. For example, a Köhler arrangement can be used for this purpose. The sample arrangement may in particular be an arrangement which can hold and/or provide the sample. For example, the sample arrangement can be a vessel in which a liquid can be collected, whereby the liquid can contain one or more molecules. Such molecules can be referred to as a sample. They can be examined in particular using the interference reflection microscope. Alternatively, a sample arrangement can also represent the sample itself. In this case, a sample such as a solid object can be examined directly.

The detection optics directs the light reflected and/or scattered by the sample arrangement to the detector. This typically generates a signal indicative of an intensity or intensities of light incident on the detector. For example, the detector can be a two-dimensional detector divided into pixels. This allows the recording of a two-dimensional image, which can be evaluated in a suitable manner.

With regard to the structure of the optics and the other components of the interference reflection microscope, reference is made in particular to the description of an embodiment below with reference to the attached drawing.

In particular, the light source may be temporally incoherent in that a value of a coherence length is at most 100 mm, at most 75 mm or at most 50 mm. The coherence length can be defined in particular based on the spectrum of the light source. In particular, the coherence length can be defined as the maximum wavelength squared divided by the half-width in the spectrum of the light source. Such a definition has proven to be a useful definition of a coherence length for assessing temporal coherence or incoherence. With the given values one can speak of a temporally incoherent light source. The values have proven to be particularly advantageous for the application at hand. Even with temporally incoherent light sources, the coherence length is typically not exactly zero, but is, for example, at least one wavelength.

In particular, a half-width can be defined as the width in the spectrum that connects two points at which the intensity, seen from a maximum, is half that of the maximum.

In particular, the light source may be a superluminescent light-emitting diode or a superluminescent diode. Such superluminescent light-emitting diodes generate spatially coherent and temporally incoherent light, which has proven to be advantageous for the present application for the reasons already mentioned. In principle, however, the use of other light sources is also possible, provided they have the required properties.

Typically, the light source is not a laser light source. Laser light sources are typically resonant feedback optical amplifiers that generate light based on stimulated emission. Laser light sources are typically not suitable for the application relevant here.

In particular, the light source can be spatially coherent in that a value of an area over which the emitted light has a fixed phase relationship is at least 1 mm², at least 5 mm², at least 10 mm², at least 100 mm², at least 250 mm² and/or a total radiating area of the light source. This has proven to be a useful definition of a coherence surface for defining a spatially coherent light source. With the given values one can assume a spatially coherent light source that provides the required performance and enables the necessary light power density to illuminate the sample.

It should be understood that the given definitions of temporal incoherence and spatial coherence can also be understood as alternatives to the formulations used in claim 1 of the application.

Preferably, there is no attenuating filter in the beam path from the sample arrangement through the detection optics to the detector. An attenuating filter is understood to mean, in particular, an element whose task is to attenuate the light beam, in particular to attenuate it considerably, for example by at least one, two or three orders of magnitude. Other optical elements such as lenses, which for technical reasons never have 100% transmission, or beam splitters, which have the purpose of splitting a beam and thus naturally only allow a part of the incident light to pass through in a certain direction, are not considered attenuating filters. By omitting an attenuating filter, it can be advantageously achieved that a significantly higher proportion of the reflected light hits the detector and thus a lower power density can be used for excitation. This allows longer exposure times without damaging samples.

In particular, in the beam path from the sample arrangement through the detection optics to the detector, at least 10%, at least 25%, at least 50%, at least 80% or at least 90% of the light reflected from the sample arrangement can reach the detector.

Such values can typically be achieved if, for example, usage of an attenuating filter in this beam path is waived. The positive effects already described can be achieved due to the high transmission from the sample arrangement to the detector. The values mentioned are also realistic, for example, if there is a beam splitter in the beam path from the sample arrangement to the detector, which inevitably does not allow part of the light to pass through to the detector but redirects it in another direction.

If a proportion of light is mentioned herein, this may in particular refer to the power of the light which is transmitted, for example, at least to the stated proportion.

According to one embodiment, the interference reflection microscope has a beam splitter. The illumination optics can in particular direct the light from the light source onto the beam splitter and the beam splitter can in particular direct the light at least partially onto the sample arrangement. In particular, the beam splitter can direct the light reflected from the sample arrangement at least partially onto the detection optics. Such a beam splitter enables a simple and practical construction of an interference reflection microscope, since the beam splitter enables superposition of the excitation light beam and the reflected light.

The light source and/or the illumination optics can, in particular, direct the light from the light source in a polarized manner onto the beam splitter. In particular, this can be a linear polarization. In particular, the beam splitter can be polarization-sensitive in such a way that it directs at least 70%, at least 80% or at least 90% of the polarized light from the light source onto the sample arrangement. By using a polarization-sensitive beam splitter and a polarized light from the light source, it is possible to achieve a higher proportion of the light reaching the sample arrangement than when using a 50% reflecting and transmitting beam splitter. This means that less light from the light source is lost due to the splitting in the beam splitter.

In particular, it can be provided that the reflected light from the sample arrangement is polarized when impinging on the beam splitter. The beam splitter can in particular be polarization-sensitive in such a way that it can divide the polarized light reflected from the sample arrangement so that at least 70%, at least 80% or at least 90% is directed towards the detection optics. This means that a polarization-sensitive design of the beam splitter in the beam path from the sample arrangement to the detector can ensure that less light is directed from the beam splitter in a direction in which it cannot be used and that a higher proportion of the light is passed through to the detector. The polarization of the light reflected by the sample arrangement and incident on the beam splitter can be aligned in particular transversely, for example at an angle of 90° or at an angle between 85° and 95°, to the polarization of the light incident on the beam splitter from the light source. This can be achieved, for example, by using a I/4 plate between the beam splitter and the sample arrangement.

In particular, it can be provided that the illumination optics between the light source and the beam splitter and the detection optics between the beam splitter and the detector are designed completely separately from each other. A completely separate design can be understood in particular to mean that the respective optical components such as mirrors, lenses or apertures are used only for one of the two optics. This does not prevent them from being mounted together on an optical table or in a holder. It can also be provided that the illumination optics are designed completely separately from the detection optics.

In particular, it can be provided that a beam path in the illumination optics between the light source and the beam splitter and a beam path in the detection optics between the beam splitter and the detector are completely separate from each other.

In particular, this can mean that the beams do not overlap in the area mentioned and that a beam in one optic is not generated from a beam of the other optic. Typically, the beam splitter is the first optical element after the light source or the last optical element before the detector, which is hit by both the beam of the illumination optics and the beam of the detection optics. It can also be provided that a beam path in the illumination optics and a beam path in the detection optics are completely separate from each other.

The interference reflection microscope can in particular have an objective. This can in particular be arranged optically directly in front of the sample arrangement. In particular, it can be arranged between the beam splitter and the sample arrangement. Using such a lens, the light can be directed and structured specifically onto the sample arrangement. Reflected light can also be captured specifically.

For example, the objective can collimate the excitation light towards the sample arrangement. In this case, the sample arrangement is illuminated with an excitation light whose diameter remains constant at least over the relevant range. Alternatively, it is also possible for the objective to focus the excitation light onto the sample arrangement.

In particular, the illumination optics can focus the excitation light. In particular, a focus can be arranged in the beam path between the illumination optics and the objective. In particular, the focus can be arranged in a rear conjugate plane of the objective. Typically, after this focus, the beam widens again before hitting the objective and being processed in the objective in the way it is intended to hit the sample arrangement.

The illumination optics and/or the beam splitter can in particular direct the excitation light onto the objective in such a way that it is incident parallel to an optical axis of the objective. The optical axis can in particular be an axis of symmetry of the objective. In particular, it can be arranged centrally in the objective in a cross-section. By ensuring that the light is incident parallel on the objective, it is possible to ensure that the beam exits the objective parallel to this optical axis. It should be understood that “parallel” here also includes “identical”. The excitation light can also be incident on the objective in such a way that a center of the excitation light lies on the optical axis of the objective.

According to one embodiment, the illumination optics and/or the beam splitter can direct the excitation light onto the objective in such a way that a center point of the excitation light is incident adjacent to the optical axis of the objective. So it does not coincide with the optical axis. It can also be said that the center of the excitation light is spaced from the optical axis of the objective, i.e. has a non-vanishing distance. This allows asymmetric illumination of the objective to be achieved. The excitation light can exit the objective in particular at an angle to the optical axis of the objective. This allows illumination of the sample arrangement at an angle to the optical axis. In particular, the excitation light can impinge obliquely on a surface of the sample arrangement, be reflected by the sample arrangement and be reflected back to the objective. Such a reflected beam is also typically oblique to the surface of the sample arrangement. It is then typically also oblique to an optical axis of the objective.

It can be provided that the excitation light impinges on the surface of the sample arrangement at an angle of at least 0°, greater than 0°, at least 1°, at least 5°, at least 10°, at least 20° or at least 40°. It may be provided that the excitation light impinges on the surface of the sample arrangement at an angle of at most 1°, at most 5°, at most 10°, at most 20°, at most 40° or at most 80°. A suitable interval can be formed from any lower value with any larger upper value. Typically, a normal on the surface serves as a reference for defining the angle. The angle is therefore typically given to the surface normal. An angle of 0° therefore corresponds to a non-oblique incidence. The excitation light can also impinge on the surface of the sample arrangement at the Brewster angle. This allows unwanted reflections to be avoided as best as possible. The Brewster angle depends on the materials used, especially the material of the sample arrangement, which is typically glass. However, it can be easily calculated, with the corresponding formula being known.

According to one embodiment, it can be provided that the light reflected at the sample arrangement strikes the objective at a different point on the objective than the point at which the excitation light exits the objective towards the sample arrangement.

The designs just described allow oblique illumination of the sample arrangement. This can achieve in particular that in the light reflected from the sample arrangement less of directly reflected excitation light and a greater proportion of light that has interacted with the sample is contained. This allows the information content of the detected light to be further increased.

According to one embodiment, the excitation light can exit the objective parallel to the optical axis and/or it can impinge on a surface of the sample arrangement transversely to this surface. The light can, for example, be reflected back opposite to the excitation light, i.e. with an offset of exactly or at least approximately 180°, for example with an angle of at least 170° and/or at most 190°.

The objective may in particular have a numerical aperture of at least 1.1, at least 1.2, at least 1.3 or at least 1.4. Such numerical apertures have proven advantageous for typical interference reflection microscopes.

The sample arrangement may, for example, comprise a vessel for a liquid, wherein the vessel is optically transparent at least to the extent that the light directed onto the sample arrangement can penetrate and light reflected within the liquid can escape.

This means that, for example, a sample in the form of one or more molecules can be present within such a liquid, and such molecules can be observed. The vessel can be made of glass or a transparent plastic, for example. For example, the liquid can be present statically or it can be passed through the vessel as part of a flow.

According to one embodiment, the light source comprises a substrate and a waveguide that is inclined relative to the substrate. The inclined waveguide can, for example, have two parallel outer surfaces which are inclined relative to a surface of the substrate. This can produce spatially incoherent light.

For example, the waveguide can be antireflective coated on two opposite sides. This prevents the formation of modes in the waveguide, which would lead to temporally coherent light. In particular, it may be provided that the light source does not have a resonator. This can also prevent the formation of modes that would lead to temporally coherent light.

In particular, it can be provided that the light source is not a laser light source. Laser light is typically temporally and spatially coherent, making it unsuitable for the application envisaged here.

For example, the light output of the light source can be at most 10 mW, at most 20 mW, at most 100 mW or at most 1,000 mW. Such light outputs can be used for typical applications, but other light outputs are also possible.

According to an embodiment, the light source has a radiating area of at most 1 mm², at most 5 mm², at most 10 mm², at most 50 mm², at most 100 mm², at most 500 mm² or at most 1,000 mm². Such sizes of radiating surfaces of the light source have proven to be advantageous for the present design.

In particular, the light source can illuminate the sample with a power density of not more than 1,000 kW/cm², not more than 500 kW/cm², not more than 100 kW/cm², not more than 50 kW/cm², not more than 10 kW/cm², not more than 2 kW/cm², not more than 1 kW/cm² or not more than 0.5 kW/cm². Such low power densities at the sample can be used with the design provided here, since, as already mentioned, a filter in the beam path to the detector can be dispensed with. In other words, a particularly high transmission from the sample arrangement to the detector can be used, which enables the use of such small power densities. The small power densities, in turn, create the advantage that a longer exposure time is possible. The power density is indicated in particular on the sample.

In particular, the detector can be a 2D camera or a 1D camera. For example, it can be designed as a CCD detector and/or as a CMOS camera. Such designs have proven advantageous for typical applications. Typically, the detector is designed two-dimensionally so that a two-dimensional pattern or interference pattern can be advantageously detected. This can be used, for example, for photographic mass spectrometry. However, depending on the application, a one-dimensional design of the detector may also be sufficient. Typically, the detector has several pixels, each measuring a light intensity.

The disclosure further relates to a method for analyzing a sample using an interference reflection microscope. In particular, this may be an interference reflection microscope as described herein. With regard to the interference reflection microscope, all designs and variants described herein can be used. The procedure comprises in particular the following steps:
Introducing the sample into the sample arrangement or as a sample arrangement, and
Illuminating the sample using the light source, while recording at least one image using the detector.

Such a method enables advantageous analysis of a sample using the interference reflection microscope described herein, per an embodiment. The advantages already described can also be achieved with the method.

In particular, multiple images can be captured using the detector. After each image has been taken, a difference image can be generated between this image and a previously taken image or an averaged image. An averaged image can be created, for example, as a mean or median over several previously taken images. In the case of an average, an average value is typically generated for each pixel using the intensity values of the images to be averaged, especially for the same pixels. In other words, an average value can be calculated for each pixel over the respective intensity values or other measured values. It can be an arithmetic mean or a geometric mean. With a median, typically no mathematical mean is generated, but rather a value is determined at which the respective intensity value for the respective pixel is below in half of the images to be averaged and above in the other half. Such averaged images can be used in particular to provide a basis for comparison with a respective recorded image. In such averaged images, noise effects are averaged out. This can be done by calculating the mean or the median. By generating difference images, it is particularly possible to detect a change compared to previous images. This makes it possible, for example, to detect new molecules landing on a surface. These can be measured and then observed, for example, when they move away from the surface again.

For example, the sample can be one molecule or can contain several molecules. In particular, these can be organic molecules that can be dissolved in a solution. For example, the molecule or molecules may each have a mass of at least 2 kDa, at least 3 kDa or at least 10 kDa. Such molecules can be analyzed particularly advantageously, per an embodiment, by means of the method described herein and/or by means of the interference reflection microscope described herein.

In particular, a mass of one or more molecules can be determined based on one or more images or difference images. For example, automated image analysis can be used for this purpose. This can be based, for example, on artificial intelligence, neural networks and/or machine learning. The advantages of the design described herein enable longer and non-destructive illumination, per an embodiment.

In particular, several images can be taken one after the other using the detector.

A video can be created from these images. Such a video is typically a series of several images taken one after the other. This allows, for example, molecules to be observed landing on and/or moving away from a surface. A change in the orientation of molecules can also be observed.

The illumination of the sample and/or the acquisition of one or more images may, for example, take place over a continuous period of at least one minute, at least two minutes, at least five minutes, at least ten minutes or at least twenty minutes.

Such periods are typically possible using the design described herein, since the power density of the Illumination of the sample can be significantly reduced compared to known designs. In particular, the previously described power densities or other data of the light source or the interference reflection microscope can be used for this purpose.

In particular, at least some of the embodiments described herein can be used for simultaneous localization measurements and/or mass photometry. For example, they can be used to study biomolecules such as proteins or nanoparticles. In at least some of the embodiments described herein, for example, a marker can be omitted, which is otherwise typically used for nanoparticles or proteins. For example, single molecule detection, molecular weight determination or other evaluation can be carried out.

The light source can in particular be linearly polarized. This can be used as explained above, especially in conjunction with a polarization-sensitive beam splitter.

Spatial coherence typically allows light to be collimated and focused like a laser. The temporal incoherence prevents speckle patterns. Polarization enables efficient use of light output. For this purpose, for example, a polarization-sensitive beam splitter can be used, as described above. The excitation light can, for example, have a wavelength of 450 nm. Any other wavelength that is suitable for the respective purposes can also be used. The light can, for example, be collimated, focused or expanded using several lenses and cut off at, for example, two irises before it falls on a sample behind an objective. A suitable use of delay plates (I/2 or I/4) and a polarization beam splitter can reduce the loss of light output. The incident light can be reflected by sample glass surfaces and/or biomolecules or nanoparticles, it interferes and reaches the detector or camera via the detection path. For example, frame rates of more than 100 frames per second, more than 500 frames per second, more than 1,000 frames per second, more than 2,000 frames per second and/or up to 2,000 frames per second, up to 5,000 frames per second, or up to 10,000 frames per second can be recorded. Such images can then be partially averaged to create differential images. The image contrast is typically proportional to the molecular weight of the sample. Thus, for example, molecules or particles with a molecular weight of a few MDa up to the specified values can be detected and localized. When the molecules move, they can be tracked for several minutes because only a very low light output is required, which does not cause photodamage. Due to the measured background noise, the designs described here can be used to measure molecular weights down to a few kDa.

For example, protein analysis, molecular weight determination, protein complex formation, oligomerization, biomolecular interaction or interplay, macromolecule assembly, single-particle tracking, or single-molecule localization can be realized with at least some of the embodiments described herein.

It is also possible to define a temporally incoherent light source by the coherence length, which can be determined, for example, as stated above, being smaller than a distance between the light source and the nearest optical interface. Such an optical interface can be provided, for example, by a lens. Typical coherence lengths of lasers used in microscopy, on the other hand, are in the order of meters. The temporally incoherent light sources used here therefore typically have a coherence length that is, for example, at least four to six orders of magnitude smaller. In particular, the light source used here is not a laser.

A normal light-emitting diode typically has an emitting area of the order of a few square millimeters or larger. In the case of a superluminescent light-emitting diode, or more generally in the case of a light source used here, typical radiating surfaces are in the order of a few square micrometers, i.e. about six orders of magnitude smaller. With a similar beam angle, the radiated light output of a light-emitting diode is about 100 times greater than that of superluminescent light-emitting diodes, for example 500 mW for light-emitting diodes compared to 5 mW for superluminescent light-emitting diodes. Accordingly, the power density of a superluminescent light-emitting diode is typically about four orders of magnitude higher than that of a simple light-emitting diode. At the same time, however, it is significantly lower than with a laser.

Spatial coherence can also be defined, for example, by the fact that a light source has the same phase regardless of a position on a radiating surface.

### BRIEF DESCRIPTION OF THE FIGURES

Further features and advantages will become apparent to those skilled in the art from the embodiment described below with reference to the accompanying drawings. In this regard,

FIG. 1: shows an interference reflection microscope, and

FIG. 2: shows a representation of a contrast depending on a molecular mass.

### DETAILED DESCRIPTION

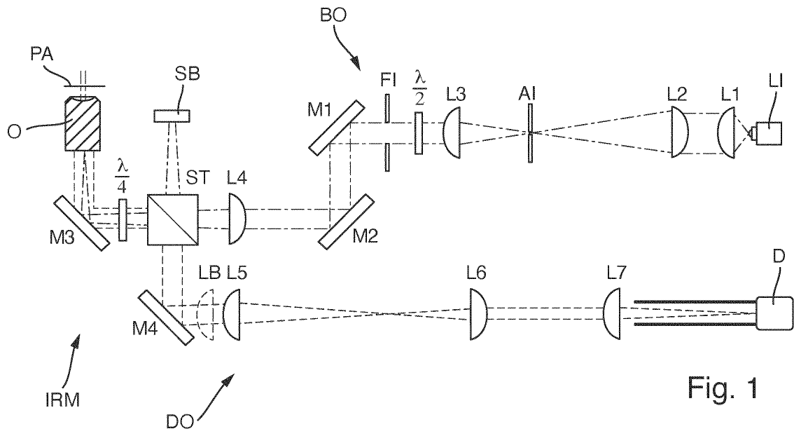

FIG. 1 shows an interference reflection microscope IRM according to an embodiment. The interference reflection microscope IRM has a light source LI. This emits light, which is used as excitation light and is shown in dash-dotted lines. This light first hits a first lens L1 and then a second lens L2. The first lens L1 collimates the light, the second lens L2 focuses it on an iris diaphragm, which is also called aperture iris AI. This eliminates disturbing components of the light. Following in the beam path there is a third lens L3, which again collimates the light. Below is a I/2 plate, by means of which the polarization of the light can be adjusted so that the polarization is optimized with respect to the beam splitter described below. After the I/2 plate there is a field iris FI for shaping the light beam as well as a first mirror M1 and a second mirror M2, which redirect the light to a fourth lens L4. This fourth lens L4 focuses the light, which then hits a beam splitter ST. The transmitted part then passes through a I/4 plate, which changes the initially linear polarization into circular polarization. The light is redirected by a third mirror M3 to an objective O, with a focus of the light focused by the fourth lens L4 being in front of the objective O. The focus lies in particular in a rear conjugate plane of the objective O. The objective O collimates the light and directs it onto a sample arrangement PA. The sample arrangement PA is implemented in the form of a transparent plate with a sample applied to it. Other solutions are also possible here, for example a reservoir for a liquid. The excitation light is reflected at the sample arrangement PA, and a component of the excitation light is further reflected by interaction with interfaces, in particular with a sample such as an organic molecule. This creates interference patterns that are contained in the reflected light. The reflected light is shown by a surrounding beam in dashed lines in FIG. 1. This is first guided via the third mirror M3 to the I/4 plate and then hits the beam splitter ST.

The beam splitter ST is designed to allow a very high proportion of the incident light with the polarization of the excitation light to pass through in the direction of the objective O, and is further designed to direct light with the polarization that the reflected light has after passing twice through the I/4 plate predominantly to a fourth mirror M4. This allows the polarization dependence of the beam splitter ST to be exploited to direct as much of the desired light as possible to the desired elements. Any unused components of the light are directed to a beam blocker SB.

The fourth mirror M4 directs the light through a Bertrand lens LB, which can be inserted into the beam path for control purposes but is normally not in the beam path for image acquisition, and then through a fifth lens L5. The light is refocused and then hits a sixth lens L6, which in turn collimates it and directs it to a seventh lens L7. This focuses the light onto a detector D. The detector D records a two-dimensional image of the incoming light and thus enables evaluation. For example, a two-dimensional image may contain an interference pattern that provides an indication of the size of a molecule in the sample arrangement PA. In particular, several images can be taken in succession to create a video or, for example, to create respective differences between images, which allow for better tracking of changes. Reference is made to the comments already made above in this regard. The first to fourth lenses L1, L2, L3, L4, the aperture iris AI, the I/2 plate, the field iris FI, and the first and second mirrors M1, M2 together form an illumination optics BO. The fourth mirror M4, the Bertrand lens LB, and the fifth to seventh lenses L5 to L7 together form a detection optics DO.

The light source LI is a spatially coherent, temporally non-coherent light source in the form of a superluminescent light-emitting diode. Due to the temporal non-coherence, it is possible to effectively prevent the formation of speckle patterns on the sample arrangement PA. As a result, light reaches the detector D which does not contain such disturbing speckle patterns, and filters known in the prior art which attenuate the light in front of the detector D in order to mask out this speckle pattern can thus be dispensed with. This in turn allows the use of a light source LI with a significantly reduced power density compared to known designs, so that longer irradiation of even sensitive samples is possible without destroying them.

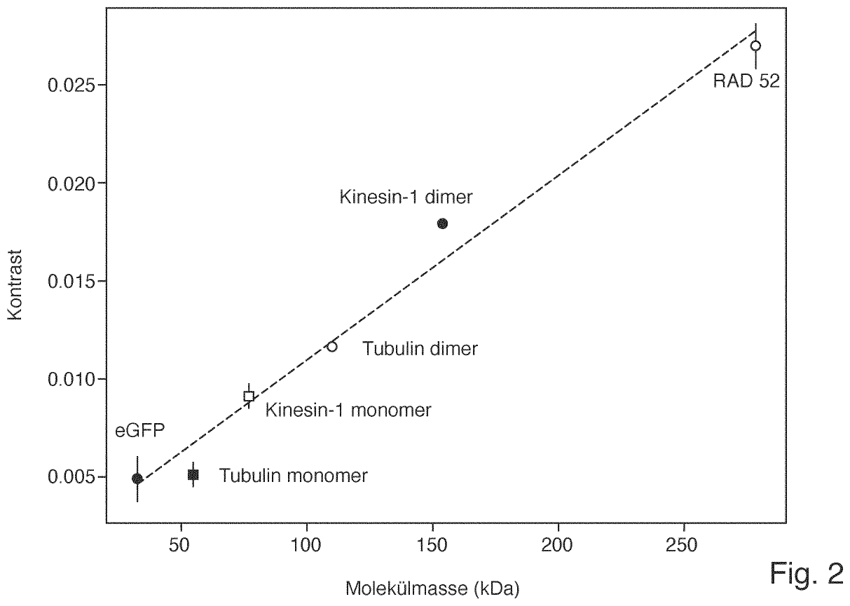

FIG. 2 shows a diagram illustrating the molecular mass in kDa for different molecules and the contrast achievable using the experimentally implemented design of an interference reflection microscope described here. Different molecules are shown, and it is observable that the contrast increases with the molecular mass. However, compared to known designs, better contrasts can generally be achieved.

The contrasts were achieved with a light power density of less than 0.5 kW/cm². With this power density, for example, a molecular mass of 100 kDa results in a contrast of 1.1%. In comparison, the implementation disclosed in Young et al., Science 360, 423-427 (2018) achieves contrasts of only 0.7% at a molecular mass of 100 kDa with a power density of 420 kW/cm². The implementation described here thus enables significantly lower power densities and at the same time even better contrast.

Mentioned steps of the method according to the disclosure can be carried out in the specified order. However, they can also be carried out in a different order as far as this is technically reasonable. The method according to the disclosure can be carried out in one of its embodiments, for example with a specific combination of steps, in such a way that no further steps are carried out. However, in principle, further steps can also be carried out, even those not mentioned.

It should be noted that features may be described in combination in the claims and in the description, for example to facilitate understanding, although they may also be used separately. The person skilled in the art will recognize that such features can also be combined independently of one another with other features or combinations of features.

References in subclaims may indicate preferred combinations of the respective features, but do not exclude other combinations of features.

As used herein, the terms “general,” “generally,” and “approximately” are intended to account for the inherent degree of variance and imprecision that is often attributed to, and often accompanies, any design and manufacturing process, including engineering tolerances, and without deviation from the relevant functionality and intended outcome, such that mathematical precision and exactitude is not implied and, in some instances, is not possible.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

LI light source
L lenses
AI aperture Iris
FI field Iris
BO illumination optics
DO detection optics
M Mirror
ST beam splitter
O objective
PA sample arrangement
SB beam blocker
LB Bertrand lens
D detector
IRM interference reflection microscope

1. Interference reflection microscope (IRM), comprising
a light source (LI),
an illumination optics (BO),
a sample arrangement (PA),
a detection optics (DO), and
a detector (D),
wherein the illumination optics (BO) directs light from the light source (LI) as excitation light onto the sample arrangement (PA),
wherein the detection optics (DO) directs light reflected from the sample arrangement (PA) onto the detector (D), and
wherein the light source (LI) is spatially coherent and temporally incoherent.

2. Interference reflection microscope (IRM) according to claim 1,
wherein the light source (LI) is temporally incoherent in that a value of a coherence length, which is defined by the maximum wavelength squared divided by the half-width in the spectrum of the light source (LI), is at most 100 mm.

3. Interference reflection microscope (IRM) according to claim 1,
wherein the light source (LI) is a superluminescent light-emitting diode.

4. Interference reflection microscope (IRM) according to claim 1,
wherein the light source is not a laser light source.

5. Interference reflection microscope (IRM) according to claim 1,
wherein the light source (LI) is spatially coherent in that a value of an area over which the emitted light has a fixed phase relationship is at least 1 mm².

6. Interference reflection microscope (IRM) according to claim 1,
wherein no attenuating filter is present in the beam path from the sample arrangement (PA) through the detection optics (DO) to the detector (D).

7. Interference reflection microscope (IRM) according to claim 1,
wherein in the beam path from the sample arrangement (PA) through the detection optics (DO) to the detector (D) at least 10% of the light reflected by the sample arrangement (PA) reaches the detector (D).

8. Interference reflection microscope (IRM) according to claim 1,
which has a beam splitter (ST),
wherein the illumination optics (BO) directs the light of the light source (LI) onto the beam splitter (ST), and the beam splitter (ST) directs the light at least partially onto the sample arrangement (PA), and
wherein the beam splitter (ST) directs the light reflected by the sample arrangement (PA) at least partially onto the detection optics (DO).

9. Interference reflection microscope (IRM) according to claim 8,
wherein the light source (LI) and/or the illumination optics (BO) direct the light of the light source (LI) in a polarized manner onto the beam splitter (ST), wherein the beam splitter (ST) is polarization-sensitive such that it directs at least 70% of the polarized light of the light source (LI) onto the sample arrangement (PA).

10. Interference reflection microscope (IRM) according to claim 9,
wherein reflected light from the sample arrangement (PA) is incident on the beam splitter (ST) in a polarized manner, and
wherein the beam splitter (ST) is polarization-sensitive such that it directs at least 70% of the polarized light reflected from the sample arrangement (PA) onto the detection optics (DO).

11. Interference reflection microscope (IRM) according to claim 8,
wherein the illumination optics (BO) between the light source (LI) and the beam splitter (ST) and the detection optics (DO) between the beam splitter (ST) and the detector (D) are designed completely separately from one another.

12. Interference reflection microscope (IRM) according to claim 8,
wherein a beam path in the illumination optics (BO) between the light source (LI) and the beam splitter (ST) and a beam path in the detection optics (DO) between the beam splitter (ST) and the detector (D) are completely separate from one another.

13. Interference reflection microscope (IRM) according to claim 1,
wherein the illumination optics (BO) are designed completely separately from the detection optics (DO).

14. Interference reflection microscope (IRM) according to claim 1,
wherein a beam path in the illumination optics (BO) and a beam path in the detection optics (DO) are completely separate from each other.

15. Interference reflection microscope (IRM) according to claim 1,
which has an objective (O) which is arranged optically directly in front of the sample arrangement (PA).

16. Interference reflection microscope (IRM) according to claim 15,
wherein the objective (O) collimates the excitation light towards the sample arrangement (PA).

17. Interference reflection microscope (IRM) according to claim 15,
wherein the objective (O) focuses the excitation light onto the sample arrangement (PA).

18. Interference reflection microscope (IRM) according to claim 15,
wherein the illumination optics (BO) focuses the excitation light,
wherein a focus is arranged in the beam path between the illumination optics (BO) and the objective (O), and/or
wherein a focus is arranged in a rear conjugate plane of the objective (O).

19. Interference reflection microscope (IRM) according to claim 15,
wherein the illumination optics (BO) and/or the beam splitter (ST) direct the excitation light onto the objective (O) in such a way that it is incident parallel to an optical axis of the objective (O).

20. Interference reflection microscope (IRM) according to claim 15,
wherein the illumination optics (BO) and/or the beam splitter (ST) direct the excitation light onto the objective (O) in such a way that a center point of the excitation light is incident adjacent to the optical axis of the objective (O).

21. Interference reflection microscope (IRM) according to claim 15,
wherein the excitation light exits the objective (O) obliquely to the optical axis of the objective (O).

22. Interference reflection microscope (IRM) according to claim 15,
wherein the excitation light impinges obliquely on a surface of the sample arrangement (PA), is reflected at the sample arrangement (PA) and is reflected back to the objective (O).

23. Interference reflection microscope (IRM) according to claim 22,
wherein the excitation light is irradiated at an angle of at least 0° to the surface normal, and/or
wherein the excitation light impinges on the surface of the sample arrangement (PA) at an angle of at most 80° to the surface normal, and/or
wherein the excitation light impinges on the surface of the sample arrangement (PA) at the Brewster angle.

24. Interference reflection microscope (IRM) according to claim 22,
wherein the light reflected at the sample arrangement (PA) impinges on the objective (O) at a different point on the objective (O) than the point at which the excitation light exits the objective (O) towards the sample arrangement (PA).

25. Interference reflection microscope (IRM) according to claim 1,
wherein the sample arrangement (PA) comprises a vessel for a liquid, the vessel being optically transparent at least to the extent that the light directed onto the sample arrangement (PA) can penetrate and light reflected within the liquid can escape.

26. Interference reflection microscope (IRM) according to claim 1,
wherein the light source (LI) has a substrate and a waveguide which is inclined compared to the substrate.

27. Interference reflection microscope (IRM) according to claim 26,
wherein the waveguide is antireflective coated on two opposite sides.

28. Interference reflection microscope (IRM) according to claim 1,
wherein the light source (LI) does not have a resonator.

29. Interference reflection microscope (IRM) according to claim 1,
wherein the light source (LI) has a radiating area of at most 1,000 mm².

30. Interference reflection microscope (IRM) according to claim 1,
wherein the light source (LI) illuminates the sample with a power density of at most 1,000 kW/cm².

31. Interference reflection microscope (IRM) according to claim 1,
wherein the detector (D) is a 2D camera or a 1D camera, and/or a CCD detector and/or a CMOS camera.

32. A method for analyzing a sample using an interference reflection microscope (IRM) according to claim 1, the method comprising the following steps:
placing the sample in the sample arrangement (PA) or as a sample arrangement (PA), and
Illuminating the sample using the light source (LI), while recording at least one image using the detector (D).

33. Method according to claim 32,
wherein a plurality of images are recorded by means of the detector (D), and
wherein after recording a respective image, a difference image is generated between this image and a previously recorded image or an averaged image, wherein an averaged image is generated as a mean value or median over a plurality of previously recorded images.

34. A method according to claim 32,
wherein the sample is one molecule or comprises multiple molecules.

35. The method of claim 34,
wherein the molecule or molecules have a mass of at least 2 kDa.

36. A method according to claim 34, further comprising the step of:
determining a mass of one or more molecules based on one or more images or difference images.

37. Method according to claim 32,
wherein a plurality of images are recorded one after the other by means of the detector (D), and
wherein a video is created from these images.

38. Method according to claim 32,
wherein the illuminating the sample and/or the taking of one or more images takes place over a continuous period of at least 1 min.
